(19) United States
(12) Patent Application Publication
(10) Pub. No.: US 2025/0140829 A1
(43) Pub. Date: May 1, 2025

(54) METHOD FOR THE PREPARATION OF PRE-LITHIATED LIMN2O4

(71) Applicant: Pacific Industrial Development Corporation, Ann Arbor, MI (US)

(72) Inventors: Bing Tan, Ann Arbor, MI (US); Yuhao Liao, Ann Arbor, MI (US)

(21) Appl. No.: 18/835,414

(22) PCT Filed: Feb. 21, 2023
(86) PCT No.: PCT/US2023/013467

§ 371 Date: Aug. 2, 2024

Related U.S. Application Data
(60) Provisional application No. 63/313,759, filed on Feb. 25, 2022.

(51) Int. Cl. H01M 4/505; C01G 45/1242; H01M 4/36

(52) U.S. Cl. CPC H01M 4/505; C01G 45/1242; H01M 4/364; C01P 2002/52; C01P 2002/72; C01P 2006/40

(57) ABSTRACT

A process of preparing a Li₁+ₓMn₂O₄ product (wherein. 0<x≤1) for use as a cathode active material in an energy storage device. The process including stirring together LiMn₂O₄, a lithium (Li) precursor, and an organic compound to form a slurry, wherein the organic compound has at least two hydroxyl (—OH) groups. Placing the slurry into a container that is subsequently sealed, such that the sealed container is configured to generate its' own autogenous pressure. Exposing the slurry in the sealed container to a temperature in the range of about 80° C. to about 250° C. for a period of time that ranges from about 1 hour to about 48 hours to form the Li₁+ₓMn₂O₄ product. Collecting the Li₁+ₓMn₂O₄ product from the sealed container. Using the Li₁+ₓMn₂O₄ product as a cathode active material in an energy storage device.

### FIELD

This invention generally relates to energy storage devices, such as rechargeable batteries. More specifically, the present disclosure provides a method of preparing pre-lithiated LiMn₂O₄ for use as a cathode active material in an energy storage device.

### BACKGROUND

The statements in this section merely provide background information related to the present disclosure and may not constitute prior art.

Conventional lithium ion cells used in electric vehicles generally incorporate an anode (e.g., graphite, etc.) a cathode (e.g., lithium metal oxide/phosphate, etc.) and an organic electrolyte containing LiPF₆. One issue with these conventional cells is that they may cause a fire during a thermal runaway situation, mainly resulting from the interaction between the organic electrolyte and the graphite anode. In addition, since the active graphite material used in the anode exhibits a limited amount of specific capacity (i.e., theoretical=372 mAh/g), the energy density of the cell becomes restricted. In order to improve overall safety and increase energy density, the battery industry has been interested in the development of lithium metal cells that use non-flammable electrolytes, including solid-state electrolytes. However, there are many challenges associated with the commercialization of this type of cell.

One of these challenges is the increased cost of using thin lithium foil as the anode in order to compensate for the lithium lost on the anode-side of the cell during cycling. These thin lithium foils, which are generally ≤20 micrometers (μm), are difficult and expensive to produce because of their softness and the high reactivity of lithium metal.

In order to reduce the cost of production, it is necessary to avoid using thin lithium metal foil and instead use an “anode-free” design. However, cells with an “anode-free” design generally lack good cycling capacity because there is not any or at least insufficient lithium to continually replenish the lithium lost on the anode-side of the cell. Therefore, a continual need exists for the development of a low-cost, “anode-free” battery that can provide lithium to the anode current collector similar to the use of thin lithium foils in order to compensate for the lithium loss that occurs during cycling.

Pre-lithiated LiMn₂O₄ (i.e., Li₁₊ₓMn₂O₄ with 0<x≤1) may be used as an cathode active material to pair with an anode active material having low Coulombic Efficiency at the 1st cycle. With the recent emergence of new anode active materials, such as Si and SiO, there is an urgent need to use such pre-lithiated cathode active materials.

Three processes are available for the preparation of pre-lithiated LiMn₂O₄. First, pre-lithiated LiMn₂O₄ may be prepared through chemical lithiation in an organic solvent using highly reactive butyllithium dissolved in an ether solvent. The use of highly reactive butyllithium with a highly flammable, ether solvent makes this process extremely challenging for commercial utilization. Second, a solid state process using LiI as a reducing agent at a temperature of about 460° C. may be used to prepare pre-lithiated LiMn₂O₄. However, the by-product(s) of this reaction, i.e., I₂ or LiI₃, have low boiling points and can easily be deposited onto the internal surface of the reactor. Thus, this reaction requires the use of frequent washing and extensive cleaning protocols, typically using excessive amounts of acetonitrile to wash/remove the by-product(s) from contaminating the product and for cleaning the reactor. Third, a microwave process may be used to reduce LiMn₂O₄ with tetraethylene glycol. However, this process needs substantial capital investment in large microwave equipment suitable for large-scale production, which is challenging with respect to technology, cost, and integration considerations. Therefore, there is a need to find an alternative process for the preparation of pre-lithiated LiMn₂O₄ or Li₁₊ₓMn₂O₄ that is less challenging with respect to commercial viability.

### SUMMARY

This disclosure generally provides a process for the preparation of a Li₁₊ₓMn₂O₄ product, wherein 0<x$1. This process comprises the steps of stirring together LiMn₂O₄, a lithium (Li) precursor, and an organic compound having at least two hydroxyl (—OH) groups to form a slurry; placing the slurry into a container that is subsequently sealed, such that the sealed container is configured to generate its' own autogenous pressure; exposing the slurry in the sealed container to a temperature in the range of about 80° C. to about 250° C. for a period of time that ranges from about 1 hour to about 48 hours to form the Li₁₊ₓMn₂O₄ product; and collecting the Li₁₊ₓMn₂O₄ product from the sealed container.

According to another aspect of the present disclosure, the organic compound may comprise one or more vicinal diols or glycols, germinal diols, 1,3-diols, triols, phenols, and/or polyols. Alternatively, the organic compound is a glycol, glycerol, or a combination thereof. Alternatively, the organic compound is ethylene glycol, propylene glycol, tetraethylene glycol, or a mixture thereof.

According to one aspect of the present disclosure the lithium precursor may be LiOH and/or a hydrate thereof (LiOH*H₂O). The lithium (Li) precursor and the LiMn₂O₄ used in forming the mixture may be present in a molar ratio of Li precursor:LiMn₂O₄ that is in range of about 0.05 to about 3.00; alternatively, the .molar ratio of Li precursor to LiMn₂O₄ is in range of about 0.20 to about 1.20; alternatively, the molar ratio of Li precursor:LiMn₂O₄ is in range of about 0.30 to 1.00.

When desirable, the slurry includes an additional solvent, which in combination with the organic compound forms a liquid component in the slurry. The slurry may have a mass ratio of solids to liquids that is greater than 1/50 and less than 100/1. Alternatively, the slurry has a mass ratio of solids/liquids that is greater than 1/10; alternatively, the slurry has a mass ratio of solids/liquids that is greater than 1/1; alternatively, the mass ratio of solids to liquids that is greater than 2/1 and less than 50/1.

According to another aspect of the present disclosure, the LiMn₂O₄ may be doped with at least one additional metal element or non-metal element in an amount that ranges from 0.1 wt. % to 1.0 wt. % relative to the overall weight of the LiMn₂O₄. This at least one additional metal element or non-metal element may be selected from the group consisting of aluminum (Al), magnesium (Mg), calcium (Ca), boron (B), nitrogen (N), fluorine (F), nickel (Ni), and cobalt (Co).

According to yet another aspect of the present disclosure, the temperature may alternatively, be in the range from 100° C. to 250° C.; alternatively, the temperature is in the range of 110° C. to 200° C.; alternatively, the temperature is in the range of 130° C. to 170° C.

In yet another aspect of the present disclosure, the Li₁₊ₓMn₂O₄ product may be collected by removing the Li₁₊ₓMn₂O₄ product from the sealed container followed by filtering, washing, and drying the Li₁₊ₓMn₂O₄ product. The Li₁₊ₓMn₂O₄ product may be dried at a temperature that ranges from about 110° C. to about 250° C. The Li₁₊ₓMn₂O₄ product may be dried in air, an inert atmosphere, or under vacuum.

According to another aspect of the present disclosure, an energy storage device is provided that comprises a positive electrode having a cathode active material that is at least partially formed of a Li₁₊ₓMn₂O₄ product prepared according to the process described above and further defined herein. When desirable, the cathode active material may be comprised entirely of the Li₁₊ₓMn₂O₄ product. The cathode active material may include one or more conventional cathode active materials selected from the group consisting of pristine LiMn₂O₄, LiFePO₄, LiFeₓMn_{y}PO₄ (i.e., x+y=1.0, 0.1>x≤0.5, and 0.5≥y≤0.9), lithium nickel manganese cobalt oxides (NCM or Li-NCM), LiCoO₂, LiNi_{0.5}Mn_{1.5}O₄, and sulfur. When a conventional cathode active material is present, the cathode active material comprises a mass ratio of the Li₁₊ₓMn₂O₄ to the conventional cathode active material that is in the range from about 99:1 to about 1:99.

Further areas of applicability will become apparent from the description provided herein. It should be understood that the description and specific examples are intended for purposes of illustration only and are not intended to limit the scope of the present disclosure.

### DESCRIPTION OF THE DRAWINGS

In order that the disclosure may be well understood, there will now be described various forms thereof, given by way of example, reference being made to the accompanying drawings. The components in each of the drawings may not necessarily be drawn to scale, but rather emphasis is placed upon illustrating the principles of the invention.

FIG. 1 is a flowchart of a method of forming a prelithiated LiMn₂O₄ or Li₁₊ₓMn₂O₄ (0<x≤1) product according to the teachings of the present disclosure.

FIG. 2 is a graphical comparison of the x-ray diffraction (XRD) patterns for several samples (R-1, R-4) of Li₁₊ₓMn₂O₄ prepared according to the teachings of the present disclosure against a sample (R-2) prepared using a different reducing agent.

FIG. 3 is a graphical comparison of the x-ray diffraction (XRD) patterns for a pristine LiMn₂O₄ sample (C-1) against a sample (R-8) of Li₁₊ₓMn₂O₄ prepared according to the teachings of the present disclosure.

FIG. 4 is a graphical plot of voltage as a function of specific capacity for the 1st charge/discharge cycle for a cell containing pristine LiMn₂O₄ (C-1) as the active cathode material against cells containing pre-lithiated Li₁₊ₓMn₂O₄ (R-1, R-8) cathode active materials prepared according to the teachings of the present disclosure.

FIGS. 5A/5B are schematic representations of a cell of an “anode-free” design incorporating the prelithiated Li₁₊ₓMn₂O₄ product formed according to the process of FIG. 1 as an active cathode material.

The drawings described herein are for illustration purposes only and are not intended to limit the scope of the present disclosure in any way. It should be understood that throughout the description and drawings, corresponding reference numerals indicate like or corresponding parts and features.

### DETAILED DESCRIPTION

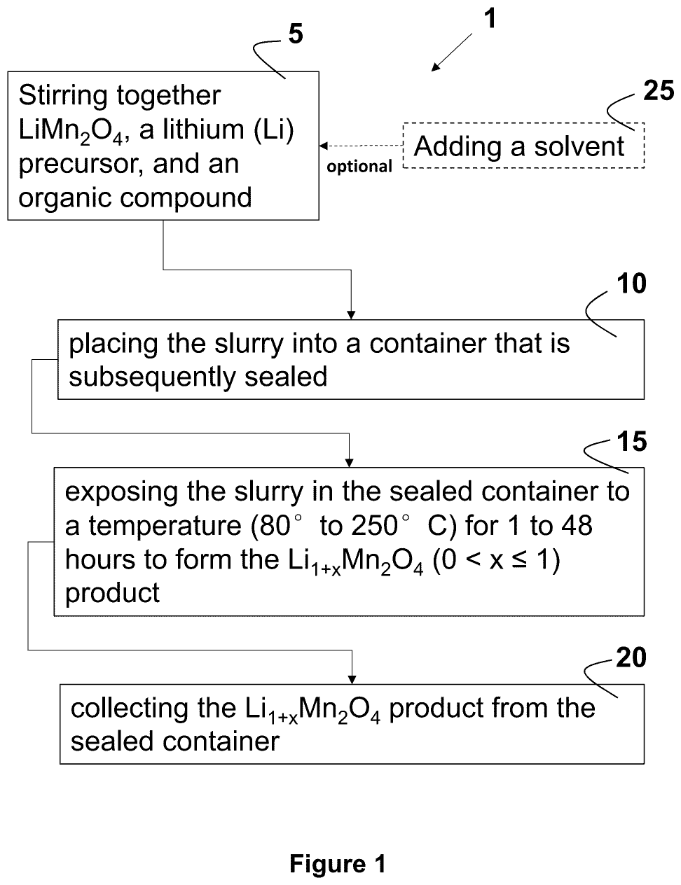

The following description is merely exemplary in nature and is in no way intended to limit the present disclosure or its application or uses. The present disclosure generally provides a method of synthesizing pre-lithiated LiMn₂O₄ through the use of a hydrothermal process involving LiMn₂O₄, a lithium precursor, and an organic compound as the reducing agent with the optional presence of an additional solvent. Referring now to FIG. 1, this method 1 comprises mixing 5 LiMn₂O₄ with a lithium precursor and an organic compound that has at least two hydroxyl (—OH) groups to form a slurry. This slurry is then placed 10 into a container, e.g., an autoclave, which is subsequently sealed. Once sealed, the container is configured to generate its' own autogenous pressure. The slurry in the sealed container is then exposed 15 to an elevated temperature, for example, 80° C. to 250° C. for one or more hours, e.g., up to 48 hours. A brownish powder is collected 20 by various routes, such as for example, without limitation, drying the product in air with or without washing. Since there is no highly flammable, organic solvent used in this process, the process may be considered safe. In addition, since autoclave processes are widely utilized in the industrial production of zeolites and other inorganic materials, the practicability of industrial scale-up for such a process has been established.

The pre-lithiated LiMn₂O₄ prepared according to the process of the present disclosure comprises the chemical formula shown in F−1,

Li₁₊ₓMn₂O₄, (F−1)

wherein x is within the range of 0<x<1.0; alternatively, x is within the rage of 0.1<x≤1.0. This pre-lithiated LiMn₂O₄ may be used as a pre-lithiated active cathode material in an energy storage device. The incorporation of greater than 0% up to 100% of an excess amount of lithium in the pre-lithiated active cathode material, alternatively, between 10% to 100%, changes the crystal structure of the LiMn₂O₄ from spinel to tetragonal, which can be converted back to spinel during cycling. If the lithium content in the pre-lithiated active cathode material is too high (i.e., x>1.0 in formula F−1), a non-tetragonal crystal phase will be formed that cannot be easily converted back to a spinel crystal phase during charging and the reversible capacity of the energy storage device or cell will be reduced.

The hydrothermal process that is used for the preparation of pre-lithiated LiMn₂O₄ utilizes a process temperature that ranges from about 80° C. to about 250° C., alternatively, from about 110° C. to about 200° C., alternatively, from about 130° C. to about 170° C. The period of time that the slurry is exposed to the process temperature may range from a few hours to tens of hours, alternatively, from 1 hour to about 48 hours, alternatively from about 2 hours to about 24 hours, alternatively, from about 4 hours to about 20 hours. Generally, the time-period will be shorter with the use of a higher temperature. For example, when a temperature above 200° C. is used, the reaction may be completed in 1 to 4 hours. When a temperature below 200° C. is used, the time period will take longer, for example, greater than 4 hours; alternatively, greater than 8 hours.

For the purpose of this disclosure, the terms “about” and “substantially” as used herein with respect to measurable values and ranges refer to the expected variations known to those skilled in the art (e.g., limitations and variability in measurements).

For the purpose of this disclosure, the terms “at least one” and “one or more of” an element are used interchangeably and may have the same meaning. These terms, which refer to the inclusion of a single element or a plurality of the elements, may also be represented by the suffix “(s)” at the end of the element. For example, “at least one glycol”, “one or more glycols”, and “glycol(s)” may be used interchangeably and are intended to have the same meaning.

The LiMn₂O₄ that is utilized as a starting material in the reaction process according to the present disclosure may be prepared according to one or more separate processes. Thus, the LiMn₂O₄ may exhibit various morphologies, properties, and variations in overall composition. For example, the LiMn₂O₄, without limitation, may exhibit a spherical shape with an average particle size (D₅₀) that is in the range of about 0.1 micrometer (μm) to about 100 micrometers (μm), alternatively, about 1 μm to about 30 μm. Alternatively, the LiMn₂O₄ may exhibit an irregular shape with an average particle size (D₅₀) that is in a similar range as described above without exceeding the scope of the present disclosure.

When desirable, the LiMn₂O₄ may also be doped with one or more additional metal and/or nonmetal elements or coated with various compositions containing such additional metal and/or nonmetal elements. More specifically, the LiMn₂O₄ may be doped or coated with at least one element selected from a group comprising all metals and non-metals, including, without limitation, or consisting of aluminum (Al), magnesium (Mg), calcium (Ca), boron (B), nitrogen (N), fluorine (F), nickel (Ni), and cobalt (Co). The additional metal or nonmetal elements may be present in an amount ranging from 0.1 wt. % to about 10 wt. %, alternatively, from about 1 wt. % to about 5 wt. % relative to the overall weight of the LiMn₂O₄.

The lithium precursor is a lithium salt that is capable of lithiating LiMn₂O₄, e.g., forming a brownish powder, in the process of the present disclosure under the conditions defined above and as further described herein. For example, the lithium precursor may include, but not be limited to, LiOH and/or the hydrate thereof, i.e., LiOH*H₂O. Several salts, such as lithium acetate, lithium nitrate, and lithium carbonate, are excluded from the definition of the lithium precursor because in the process and under the conditions described in the present disclosure, the LiMn₂O₄ is not lithiated, e.g., these as-made powders appear to remain black in color.

In general, the molar ratio between the lithium precursor and LiMn₂O₄ (e.g., LiOH:LiMn₂O₄) used in the process of the present disclosure is in the range of 0.05 to 3. Since the lithium salt (e.g., LiOH) may react with the solvent (e.g., glycols, etc.) at high temperature, an excess amount of lithium precursor may be necessary to fully lithiate the LiMn₂O₄. In addition, the amount of the lithium precursor needed to fully lithiate the LiMn₂O₄ will also be higher, when a lower mass ratio of solid to reducing agent is present in the slurry formed during the process. The molar ratio of the lithium precursor to LiMn₂O₄ (e.g., LiOH:LiMn₂O₄) may alternatively, range from about 0.1 to about 2.5, alternatively, from about 0.2 to about 1.2, alternatively, from about 0.3 to about 1.0.

The reducing agent utilized in the process of the present disclosure is an organic compound that will be reduced under hydrothermal conditions. In this sense, the process preferably utilizes an organic compound that has at least two hydroxyl (—OH) groups. Thus, the organic compound may be selected to comprise one or more vicinal diols or glycols, germinal diols, 1,3-diols, triols, phenols, and/or polyols. Several specific examples of such organic compounds, include, without limitation, ethylene glycol, propylene glycol, tetraethylene glycol, 2-methyl-2-propyl-1,3-propanediol, neopentyl glycol, glycerol, glycerin, 2-deoxyribose, dihydroxybenzene, sorbitol, mannitol, xylitol, maltitol, maltitol syrup, lactitol, erythritol, and isomalt. Alternatively, the organic compound is a glycol, a glycerol, or a combination thereof. Alternatively, the organic compound is ethylene glycol, propylene glycol, tetraethylene glycol, or a combination thereof. One skilled in the art will understand that it may be possible to use an organic amine as the organic compound, but is not preferred, due to the resulting odor that would be need to be addressed and hinder the success of a production process.

According to another aspect of the present disclosure, the reducing agent or organic compound may act as a solvent itself. For example, a glycol or glycerol may both act as a solvent and as the reducing agent in the process. It is also possible that more than one organic compound be utilized, such that one of the organic compounds may act as a solvent, while the other organic compound acts as the reducing agent. For example, a combination of a glycol and glycerol may function in this capacity. When desirable, an additional solvent that cannot act as a reducing agent may be utilized in combination with the organic compound.

The solid to the liquid ratio in the slurry formed during the process should be as large as possible in order to increase the overall production yield since the volume of the sealed container, e.g., autoclave, is limited. However, the solid to liquid ratio also limited because it is necessary for the surface of the solid to wet by the liquid in order to ensure the formation of a homogenous Li₁₊ₓMn₂O₄ product. The mass ratio between the solids (i.e., LiMn₂O₄ and LiOH*H₂O) and the liquid (i.e. reducing agent or reducing agent and solvent) should be greater than 1/100, alternatively, greater than 1/10, alternatively, greater than 1/1, or alternatively, greater than 2/1, but less than 100/1, alternatively, less than 50/1, alternatively less than 20/1, or alternatively less than 10/1.

Once the reaction is completed, the pre-lithiated LiMn₂O₄, i.e., the Li₁₊ₓMn₂O₄ (with 0<x≤1) product may be collected via various or different routes. According to one route, the product may be collected by filtering and washing the as-collected wet material with an organic solvent or water. The washed material is then dried in air to remove any liquid. According to another route, the product may be collected by heating the as-collected wet material in an oven. According to yet another route, the product may be collected by heating the as-collected wet material in air at a temperature ≥110° C., alternatively, about 200° C. In yet another route, the product may be collected by heating the as-collected wet material in an inert gas environment at a temperature that is in the range of 100° C. to 250° C., alternatively, about 200° C. The as-prepared pre-lithiated LiMn₂O₄ is relatively stable in the presence of water or moisture. Thus, organic solvents having a relatively high moisture level may be used for the synthesis and the washing of the pre-lithiated product. All of the collection processes may be performed in air without the need to restrict or control humidity.

The pre-lithiated LiMn₂O₄ may be used alone as the active cathode material or it may be used in combination with another active cathode material. Several examples of such conventional active cathode materials include, without limitation, pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur. When the pre-lithiated cathode material is used in combination with another active cathode material, the mass ratio of the pre-lithiated material to the other, e.g., conventional, material may range from about 99:1 to about 10:90 depending on the application requirements. Alternatively, the mass ratio for pre-lithiated material to the conventional or other active material is greater than 100:0 and less than or equal to 10:90; alternatively, between about 90:10 and 20:80; alternatively, in the range of about 80:20 to about 30:70; alternatively, 70:30 to 40:60; alternatively, about 60:40 to about 50:50; alternatively between greater than 100:0 and less than or equal to 51:49.

The specific examples provided in this disclosure are given to illustrate various embodiments of the invention and should not be construed to limit the scope of the disclosure. The embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

### General Test Parameters for Pre-Lithiated Cathode Active Materials

To make a pre-lithiated electrode (see samples R-2 through R-8), a composition comprising 97 wt. % of pre-lithiated active cathode powders (Li₁₊ₓMn₂O₄, 1.5 wt. % carbon nanotubes (CNT), and 1.5 wt. % polyvinylidene fluoride (PVDF) was coated onto an aluminum foil and calendared. A similar electrode was prepared using pristine LiMn₂O₄ powder in place of the pre-lithiated active cathode powder for use as a control or reference electrode (see sample C-1).

Each of the electrodes (see samples R-1 to R-8 and C-1) were then tested in an “anode-free” single-layer pouch cell against a Cu foil wherein the voltage ranged from 3.0 V to 4.25 V at about C/10. The cell was clamped together with two clips. The charge/discharge curves at the 1st cycle for the cells containing the pre-lithiated electrodes (see samples R-1 to R-8) and the reference electrode (see sample C-1) were measured and the 1st Coulombic Efficiency (CE), as well as the 1st discharge capacity determined.

During operation, it is desirable that the Coulombic or current efficiency and the discharge capacity exhibited by the battery remains relatively constant. The Coulombic efficiency describes the charge efficiency by which electrons are transferred within the battery. The discharge capacity represents the amount of charge that may be extracted from a battery. As used herein, Coulombic Efficiency (CE) is defined as the ratio of the discharge capacity (mAh/g) to the charge capacity (mAh/g). For each electrode, the CE is generally less than 100%, in particular, for the 1st charge/discharge cycle because of irreversible capacity loss that occurs due to the occurrence of side reactions. The 1st cycle CE of an “anode-free” cell using these pre-lithiated cathode active materials may be <100%, alternatively, <90%; alternatively, <80%; alternatively, <70%; and alternatively, <60% as controlled by the amount of the lithium incorporated into the active cathode materials via the use of the pre-lithiation reaction. In this present disclosure, a lower 1st cycle CE, corresponds to an increase in the amount of lithium added or deposited within the structure of the active cathode material.

### Examples—Synthesis and Test Results for Samples (R-1 to R-8 and C-1)

A series of samples were prepared using the hydrothermal process according to the reaction conditions set forth in Table 1. A control sample (C-1) that comprised only the starting material, LiMn₂O₄ was utilized. The difference between samples R-1 and R-2 is the composition of the organic compound used as the reducing agent. Sample R-1 used propylene glycol as the reducing agent, while sample R-2 used isopropyl alcohol. A brownish powder was obtained from the reaction in R-1, suggesting that the LiMn₂O₄ was reduced to Li₁₊ₓMn₂O₄ product (0<x≤1), which was then confirmed by measurement of an x-ray diffraction (XRD) pattern for the sample and by the electrochemical performance achieved. The electrochemical performance exhibited by each sample (R-1 to R-8 and C-1) when used as an active cathode material is provided in Table 2.

The powder obtained as sample R-2 after performing the hydrothermal process remained black in color (see Tables 1 or 2). The color of sample R-2 is the same color as the pristine LiMn₂O₄ starting material (sample C-1), thereby, suggesting that the LiMn₂O₄ was not reduced by the isopropyl alcohol. Thus, sample R-2 confirms that the organic compound should have at least two hydroxyl groups.

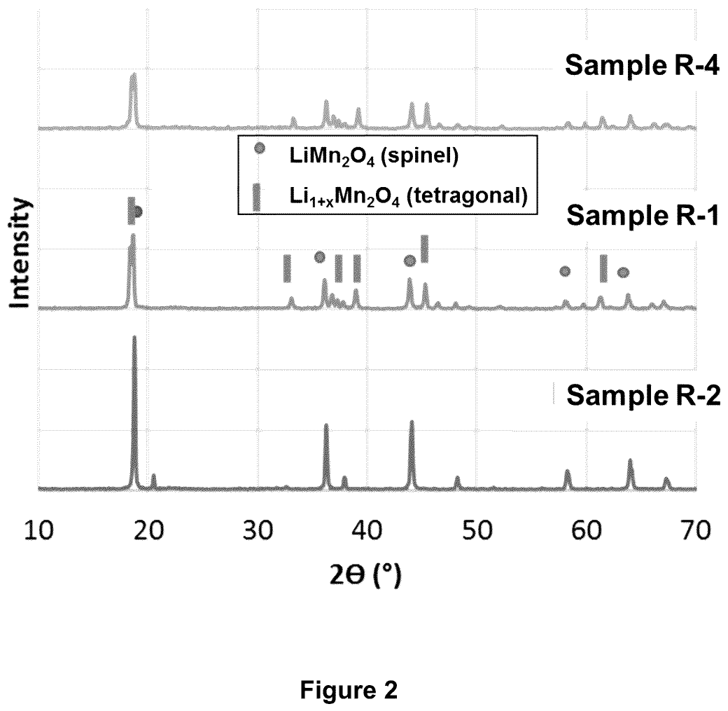

The x-ray diffraction (XRD) patterns for R-1 and R-2 are compared in FIG. 2. No peaks associated with a Li₁₊ₓMn₂O₄ product were observed for sample R-2, while sample R-1 showed a mixture of tetragonal Li₁₊ₓMn₂O₄ product (0<x≤1) and spinel LiMn₂O₄. A pure Li₁₊ₓMn₂O₄ product can be prepared by increasing the lithium precursor (i.e., LiOH) content that is present in the reaction slurry. The first Coulombic Efficiency (1st CE) of sample R-1 was 54%, which was much lower than the 96% exhibited by the pristine LiMn₂O₄ (see sample C-1), thereby, confirming that sample R-1 was reduced (e.g., lithiated) during the reaction.

TABLE 1
Reaction Conditions

| | | Li | Organic | Organic | Tem- | Washing | | |
|---|---|---|---|---|---|---|---|---|
| Sample | LiMn₂O₄ | Precursor, | Compound | Compound | perature | Solvent | Drying | Product |
| ID | (g) | LiOH (g) | Type | (g) | (° C.) | Type | Conditions | Color |
| C-1 | N/A | N/A | N/A | N/A | N/A | N/A | N/A | Black |
| R-1 | 4.75 | 1.00 | propylene | 60 | 130 | isopropyl | 110° C. | Brown |
| | | | glycol | | | alcohol | vacuum | |
| R-2 | 4.75 | 1.00 | isopropyl | 60 | 130 | isopropyl | 110° C. | Black |
| | | | alcohol | | | alcohol | vacuum | |
| R-3 | 4.75 | 1.00 | propylene | 60 | 150 | isopropyl | 110° C. | Brown |
| | | | glycol | | | alcohol | vacuum | |
| R-4 | 4.75 | 1.00 | propylene | 60 | 170 | isopropyl | 110° C. | Brown |
| | | | glycol | | | alcohol | vacuum | |
| R-5 | 4.75 | 1.00 | propylene | 60 | 130 | water | 110° C. | Brown |
| | | | glycol | | | | oven | |
| R-6 | 4.75 | 1.00 | propylene | 1.00 | 130 | N/A | 110° C. | Brown |
| | | | glycol | | | | vacuum | |
| R-7 | 4.75 | 1.00 | propylene | 2.00 | 130 | N/A | 110° C. | Brown |
| | | | glycol | | | | vacuum | |
| R-8 | 4.75 | 0.33 | propylene | 2.00 | 130 | N/A | 200° C. | Brown |
| | | | glycol | | | | air | |

The difference between samples R-1, R-3, and R-4 is the temperature at which each reaction was conducted. All three of the products produced in these reactions were brownish in color and when used as an active cathode material exhibited a low Coulombic Efficiency at the 1st cycle (1st CE), which is consistent with the expectation for the lithiation of LiMn₂O₄ to form a Li₁₊ₓMn₂O₄ product (0<x≤1). A comparison of the x-ray diffraction (XRD) patterns for samples R-1 and R-4 is also shown in FIG. 2. Both of these samples were found by the measured XRD pattern to comprise a mixture of a tetragonal Li₁₊ₓMn₂O₄ product (0<x≤1) and spinel LiMn₂O₄.

TABLE 2
Properties and Test Results

| Sample | Product | 1st CE | 1st Discharge |
|---|---|---|---|
| ID | Color | (%) | Capacity (mAh/g) |
| C-1 | Black | 96 | 111 |
| R-1 | Brown | 54 | 105 |
| R-2 | Black | N/A | N/A |
| R-3 | Brown | 40 | 97 |
| R-4 | Brown | 35 | 95 |
| R-5 | Brown | 44 | 92 |
| R-6 | Brown | 34 | 68 |
| R-7 | Brown | 44 | 95 |
| R-8 | Brown | 66 | 94 |

Sample R-6 confirms that the Li₁₊ₓMn₂O₄ product (0<x≤1) has relatively good stability in the presence of water or moisture, since water was used to wash the collected powder prior to being dried in an oven. In addition, even after such exposure to water/moisture, sample R-5 still exhibited a specific capacity of 92 mAh/g when used as an active cathode material.

Samples R-6 and R-7 demonstrate that the amount of the organic compound may be substantially reduced (e.g., to as little as 1 to 2 grams) in comparison to the amount of LiMn₂O₄ present (e.g., 4.75 grams) in the reaction slurry. When used as an active cathode material, the specific capacity of the sample formed using 1 gram of propylene glycol (see sample R-6) is very low (68 mAh/g). This result is most likely due to inhomogeneous mixing of the LiMn₂O₄ and LiOH. However, the specific capacity exhibited by the active cathode material formed from the use of 2 grams of propylene glycol (see sample R-7)) was found to be much higher (95 mAh/g).

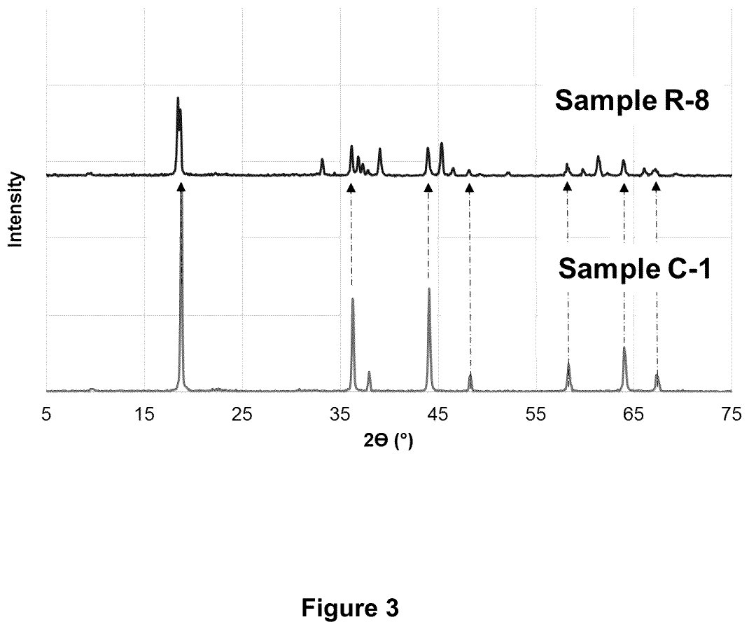

The molar ratio between the Li precursor (e.g., LiOH or LiOH*H₂O) and LiMn₂O₄ used in the reaction can range from 0.1 to 2, alternatively, from about 0.2 to about 1.2, alternatively, from about 0.3 to about 1.0. Samples R-1 and R-3 to R-7 demonstrate a molar ratio of 1:1, while sample R-8 demonstrates a molar ratio of 0.3. Sample R-8 when used as an active cathode material exhibits a low 1st CE of 66% with a specific capacity of 94 mAh/g. FIG. 3 provides the x-ray diffraction (XRD) pattern measured for sample R-8 in comparison to sample C-1. The XRD pattern demonstrates that sample R-8 is comprised of both a spinel Li₂Mn₂O₄ phase (see sample C-1) and a tetragonal Li₁₊ₓMn₂O₄ phase.

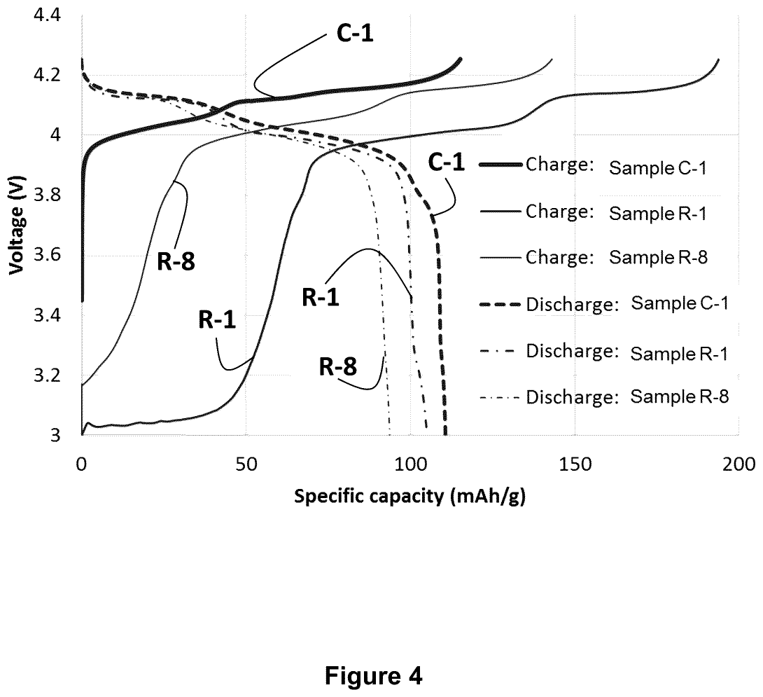

Referring now to FIG. 4 graphs of the 1st cycle charge/discharge voltage curves measured for samples C-1 (pristine LiMn₂O₄), sample R-1 (Li₁₊ₓMn₂O₄ prepared using a 1:1 ratio of Li precursor to LiMn₂O₄), and sample R-8 (Li₁₊ₓMn₂O₄ prepared using a 0.3:1 ratio) are provided. FIG. 4 demonstrates that both samples R-1 and R-8 exhibit much higher charge capacities than their discharge capacities. The difference in the capacity (i.e., charge capacity minus discharge capacity) can be used to provide the lithium for the anode during the 1st cycle.

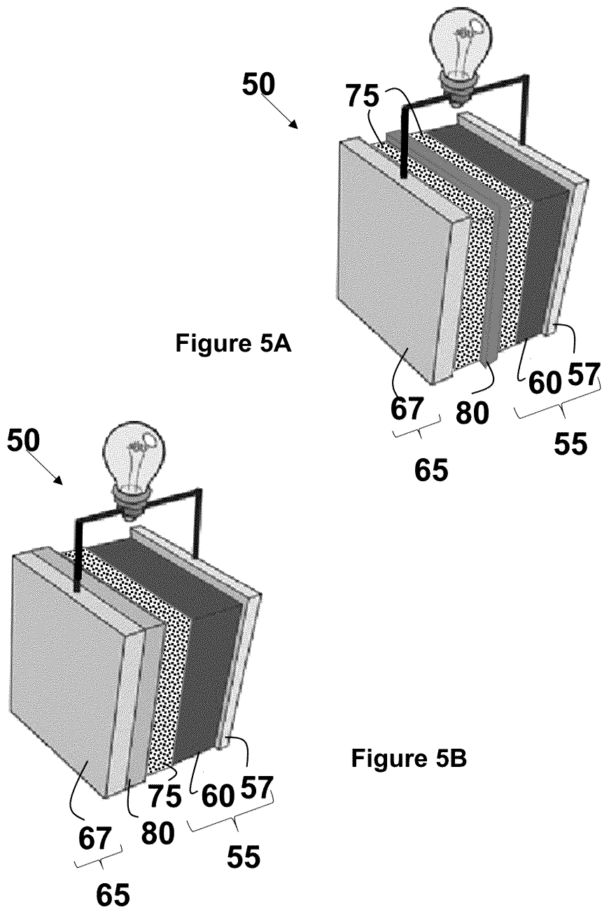

According to another aspect of the present disclosure, an energy storage device, such as a rechargeable battery cell, is provided that utilizes the pre-lithiated LiMnO₂ prepared according to the process described above as a cathode active material. One example of an energy storage device is a rechargeable lithium cell that includes an “anode-free” design as shown in FIGS. 5A and 5B. In an anode-free design, the rechargeable lithium cell 50 is made with a positive electrode 55 comprising a current collector 57 and an active material (cathode) 60, i.e., the pre-lithiated LiMn₂O₄, while the negative electrode 65 side of the cell 50 generally includes only a current collector 67. A main benefit associated with an “anode-fee” cell is that it eliminates or at least significantly reduces the electrode volume and/or mass by not incorporating any pre-deposited anode active layer onto the current collector during the fabrication of the cell.

Still referring to FIGS. 5A and 5B, the “anode-free” cell further includes a separator 80 and an electrolyte 75 that supports the reversible flow of lithium ions between the positive electrode 55 and the negative electrode 65. The separator 80 is placed between the positive electrode 55 and negative electrode 65, such that the separator 80 separates the electrodes. The separator 80 is permeable to the reversible flow of lithium ions there through. The flow of ions may be conducted by the separator (i.e., via a solid-state mechanism) or by the presence of a liquid electrolyte 75 that permeates through the porosity of the separator 80 (e.g., a membrane).

The current collector 57 in the positive 55 electrode may be made of any metal known in the art for use in an electrode of a lithium battery, such as for example, without limitation, aluminum, titanium, stainless steel, nickel, copper, carbon, zinc, gallium, silver, and combinations or alloys formed therefrom. The current collector 67 used in the negative electrode 65 may be a metallic foil that does not react with lithium ions. Several examples of such metallic foils may include, but not be limited to, Cu, Fe, Ti, Ni, Mo, W, Zr, Mn, carbon, and lithium metal alloys. Alternatively, the metallic foil for the current collector 67 of the negative electrode 65 comprises Cu, Fe, Ni, or a mixture or alloy thereof.

As used herein a “battery cell” or “cell” refers to the basic electrochemical unit of a battery. In comparison, a “battery” or “battery pack” refers to a collection of cell(s), e.g., one or more cells, and includes a housing, electrical connections, and possibly electronics for control and protection.

According to yet another aspect of the present disclosure, one or more of the anode-free cells comprising the pre-lithiated active cathode material prepared according to the process of the present disclosure may be combined to form a larger capacity battery or battery pack, such as a lithium-ion secondary battery used in an electric vehicle (EV). The one or more cells may be incorporated in series, in parallel, or in a combination thereof in order to form the battery or battery pack. One skilled in the art will also appreciate that in addition to using the “anode-free” cells in a lithium-ion secondary battery, the same principles may be used to encompass or encase one or more cells into a housing for use in another application.

The housing may be constructed of any material known for such use in the art and be of any desired geometry required or desired for a specific application. For example, lithium-ion batteries generally are housed in three different main form factors or geometries, namely, cylindrical, prismatic, or soft pouch. The housing for a cylindrical battery may be made of aluminum, steel, or the like. Prismatic batteries generally comprise a housing that is rectangular shaped rather than cylindrical. Soft pouch housings may be made in a variety of shapes and sizes. These soft housings may be comprised of an aluminum foil pouch coated with a plastic on the inside, outside, or both. The soft housing may also be a polymeric-type encasing. The polymer composition used for the housing may be any known polymeric materials that are conventionally used in lithium-ion secondary batteries. One specific example, among many, include the use of a laminate pouch that comprises a polyolefin layer on the inside and a polyamide layer on the outside. A soft housing needs to be designed such that the housing provides mechanical protection for the “anode-free” cells present in the battery.

Within this specification, embodiments have been described in a way which enables a clear and concise specification to be written, but it is intended and will be appreciated that embodiments may be variously combined or separated without parting from the invention. For example, it will be appreciated that all preferred features described herein are applicable to all aspects of the invention described herein.

Those skilled-in-the-art, in light of the present disclosure, will appreciate that many changes can be made in the specific embodiments which are disclosed herein and still obtain alike or similar result without departing from or exceeding the spirit or scope of the disclosure. One skilled in the art will further understand that any properties reported herein represent properties that are routinely measured and can be obtained by multiple different methods. The methods described herein represent one such method and other methods may be utilized without exceeding the scope of the present disclosure.

The foregoing description of various forms of the invention has been presented for purposes of illustration and description. It is not intended to be exhaustive or to limit the invention to the precise forms disclosed. Numerous modifications or variations are possible in light of the above teachings. The forms discussed were chosen and described to provide the best illustration of the principles of the invention and its practical application to thereby enable one of ordinary skill in the art to utilize the invention in various forms and with various modifications as are suited to the particular use contemplated. All such modifications and variations are within the scope of the invention as determined by the appended claims when interpreted in accordance with the breadth to which they are fairly, legally, and equitably entitled.

1. A process for the preparation of a Li₁₊ₓMn₂O₄ product, wherein 0<x≤1, the process comprising:
a. stirring together LiMn₂O₄, a lithium (Li) precursor, and an organic compound to form a slurry, wherein the organic compound has at least two hydroxyl (—OH) groups;
b. placing the slurry into a container that is subsequently sealed, such that the sealed container is configured to generate its' own autogenous pressure;
c. exposing the slurry in the sealed container to a temperature in the range of about 80° C. to about 250° C. for a period of time that ranges from about 1 hour to about 48 hours to form the Li₁₊ₓMn₂O₄ product; and
d. collecting the Li₁₊ₓMn₂O₄ product from the sealed container.

2. The process according to claim 1, wherein one or more of the following are present:
the lithium precursor is LiOH and/or a hydrate thereof (LiOH*H₂O);
the organic compound comprises one or more vicinal diols or glycols, germinal diols, 1,3-diols, triols, phenols, and/or polyols.

3. (canceled)

4. The process according to claim 1, wherein the organic compound is a glycol, glycerol, or a combination thereof.

5. The process according to claim 4, wherein the organic compound is ethylene glycol, propylene glycol, tetraethylene glycol, or a mixture thereof.

6. The process according to claim 1, wherein the lithium (Li) precursor and the LiMn₂O₄ used in forming the mixture are present in a molar ratio of Li precursor:LiMn₂O₄ that is in range of about 0.05 to about 3.00.

7. The process according to claim 6, wherein the molar ratio of Li precursor:LiMn₂O₄ is in range of about 0.20 to about 1.20.

8. The process according to claim 6, wherein the molar ratio of Li precursor:LiMn₂O₄ is in range of about 0.30 to 1.00

9. The process according to claim 1, wherein the slurry includes an additional solvent, which in combination with the organic compound forms a liquid component in the slurry;
wherein the slurry has a mass ratio of solids/liquids that is greater than 1/50 and less than 100/1.

10. (canceled)

11. The process according to claim 10, wherein the slurry has a mass ratio of solids/liquids that is greater than 1/10.

12. The process according to any of claim 11, wherein the slurry has a mass ratio of solids/liquids that is greater than 1/1.

13. The process according to claim 12, wherein the slurry has a mass ratio of solids/liquids that is greater than 2/1 and less than 50/1.

14. The process according to claim 1, wherein the LiMn₂O₄ is doped with at least one additional metal element or non-metal element in an amount that ranges from 0.1 wt. % to 1.0 wt. % relative to the overall weight of the LiMn₂O₄.

15. The process according to claim 14, wherein the at least one additional metal element or non-metal element is selected from the group consisting of aluminum (Al), magnesium (Mg), calcium (Ca), boron (B), nitrogen (N), fluorine (F), nickel (Ni), and cobalt (Co).

16. (canceled)

17. The process according to claim 1, wherein the temperature is in the range of 110° C. to 200° C.

18. The process according to claim 1, wherein the temperature is in the range of 130° C. to 170° C.

19. The process according to claim 1, wherein the Li₁₊ₓMn₂O₄ product is collected by removing the Li₁₊ₓMn₂O₄ product from the sealed container followed by filtering, washing, and then drying the Li₁₊ₓMn₂O₄ product in air, an inert atmosphere, or under vacuum at a temperature that ranges from about 110° C. to about 250° C.

20. (canceled)

21. (canceled)

22. An energy storage device having a positive electrode comprising a cathode active material that is at least partially formed of a Li₁₊ₓMn₂O₄ product prepared according to claim 1.

23. The energy storage device according to claim 22, wherein the cathode active material is comprised entirely of the Li₁₊ₓMn₂O₄ product.

24. The energy storage device according to claim 22, wherein the cathode active material further comprises one or more conventional cathode active materials selected from the group consisting of pristine LiMn₂O₄, LiFePO₄, LiFeₓMn_{y}PO₄ (i.e., x+y=1.0, 0.1≥x≤0.5, and 0.5≥y≤0.9), lithium nickel manganese cobalt oxides (NCM or Li-NCM), LiCoO₂, LiNi_{0.5}Mn_{1.5}O₄, and sulfur.

25. The energy storage device according to claim 24, wherein cathode active material comprises a mass ratio of the Li₁₊ₓMn₂O₄ to the conventional cathode active material that ranges from about 99:1 to about 1:99.
